(19) United States
(12) Patent Application Publication
(10) Pub. No.: US 2013/0022415 A1
(43) Pub. Date: Jan. 24, 2013

(54) CUTTING TOOL

(71) Applicants: Jiro Osawa, Toyokawa-City (JP); Yasuyuki Endoh, Toyokawa-City (JP); Tamotsu Nagai, Toyokawa- City (JP)

(72) Inventors: Jiro Osawa, Toyokawa-City (JP); Yasuyuki Endoh, Toyokawa-City (JP); Tamotsu Nagai, Toyokawa- City (JP)

(21) Appl. No.: 12/998,888

(22) PCT Filed: Mar. 4, 2010
(86) PCT No.: PCT/JP10/53578

§ 371 Date: Jun. 10, 2011

(51) Int. Cl. B23B 27/00; B23B 51/00; B23G 5/06; B23C 5/22

(52) U.S. Cl. 407/46

(57) ABSTRACT

To provide a cutting tool in which the amount of waste of a main body unit and a cutting head can be suppressed and oscillation at the time of a cutting process can be suppressed. In a cutting tool 100, a helisert 20 made of steel that is lower in rigidity than cemented carbide is provided between an external screw unit 32 and an internal screw unit 11. Accordingly, the external screw unit 32 and the internal screw unit 11 are prevented from being brought into contact with each other, so that a thread 33 of the external screw unit 32 and a thread 12 of the internal screw unit 11 can be prevented from being damaged. Further, oscillation of a cutting head 30 against the main body unit 10 can be absorbed by providing the helisert 20 between the external screw unit 32 and the internal screw unit 11 because steel is lower in rigidity than cemented carbide.

### TECHNICAL FIELD

The present invention relates to a cutting tool in which a cutting head can be detachably attached to a main body unit, and particularly to a cutting tool in which the amount of waste of the main body unit and the cutting head can be suppressed and oscillation at the time of a cutting process can be suppressed.

### BACKGROUND ART

As a cutting tool that is rotated and driven by a machining center or the like to cut and process a processed material, there has been known a tool made of cemented carbide from the past. The cutting tool made of cemented carbide is excellent at processing accuracy in a cutting process due to its high rigidity and less deflection as compared to that made of high-speed tool steel.

However, cemented carbide is lower in toughness as compared to high-speed tool steel and cutting blades made of cemented carbide are easily damaged. Therefore, for a solid-type cutting tool (integrated with a shank) made of cemented carbide, it is necessary to replace the whole cutting tool every time the cutting blade is damaged, thus leading to an increase in the amount of waste of the cutting tool.

On the other hand, there has been known a connectable cutting tool in which a cutting head made of cemented carbide can be detachably attached to a main body unit made of cemented carbide. When a cutting blade of the connectable cutting tool is damaged, only the cutting head is replaced and the main body unit can be reused. Thus, the amount of waste can be suppressed as compared to the solid-type cutting tool.

For example, Utility Model Registration No. 3132125 discloses a connectable cutting tool in which an external screw unit 21 protruding from a bottom end of a tool bit 20 (cutting head) made of tungsten carbide is screwed to a screw hole 11 (internal screw unit) provided at a tip end of a rod 10 (main body unit) made of tungsten carbide (cemented carbide), so that the rod 10 and the tool bit 20 are connected to each other.

### CITATION LITERATURE

### Patent Literature

Patent literature 1: Utility Model Registration No. 3132125 (FIG. 3 and the like)

### SUMMARY OF INVENTION

### Technical Problem

However, the thread of the external screw unit or the internal screw unit that connects the main body unit and the cutting head to each other is easily damaged due to an impact by oscillation in the above-described conventional connectable cutting tool because both of the main body unit and the cutting head are made of cemented carbide. In the case where the thread of the external screw unit or the internal screw unit is damaged, it is necessary to replace the main body unit or the cutting head having the damaged thread. Thus, there has been a problem of insufficient effects of suppression in the amount of waste. Further, the entire rigidity of the connectable cutting tool is lower than that of the solid type. Thus, there has been a problem that the cutting head is easily oscillated at the time of a cutting process.

The present invention has been achieved to address the above-described problems, and the object thereof is to provide a cutting tool in which a cutting head can be detachably attached to a main body unit, the amount of waste of the main body unit and the cutting head can be suppressed, and oscillation at the time of a cutting process can be suppressed.

### Solution to Problem and Advantageous Effects of Invention

According to a cutting tool described in claim 1, a helisert that is lower in rigidity than cemented carbide is mounted in an internal screw unit formed at an end of the other of a main body unit and a cutting head, and an external screw unit formed at an end of one of the main body unit and the cutting head is screwed to the helisert, so that the main body unit and the cutting head are fixed to each other. Accordingly, the helisert that is lower in rigidity than cemented carbide is provided between the external screw unit and the internal screw unit made of cemented carbide, so that the external screw unit and the internal screw unit can be prevented from being brought into contact with each other, and the damage of the threads of the external screw unit and the internal screw unit can be suppressed. As a result, the frequency of replacing the main body unit and the cutting head due to the damage of the threads is reduced, and the amount of waste of the main body unit and the cutting head can be advantageously suppressed.

Further, the helisert that is lower in rigidity than cemented carbide is provided between the external screw unit and the internal screw unit, so that oscillation of the cutting head against the main body unit can be absorbed by the helisert. As a result, oscillation at the time of a cutting process can be advantageously suppressed.

It should be noted that the helisert is a conventional member that is mounted in an internal screw made of aluminum die cast or resin that is softer than the helisert to fix or prevent wear of the internal screw due to repeated use. On the other hand, the helisert is mounted in the internal screw formed at the other of the main body unit and the cutting head made of cemented carbide that is harder than the helisert, according to claim 1. Specifically, the helisert that is softer than the external screw unit and the internal screw unit is provided between the external screw unit and the internal screw unit, so that the above-described effects of claim 1 can be obtained.

According to the cutting tool described in claim 2, the external screw unit can be strongly fastened and fixed to the helisert because the helisert is made of steel with a certain level of rigidity, in addition to the effects obtained by the cutting tool described in claim 1. Accordingly, oscillation of the cutting head at the time of a cutting process can be advantageously further suppressed.

### BRIEF DESCRIPTION OF DRAWINGS

FIG. 1(a) is a side view of a main body unit configuring a cutting tool in an embodiment of the present invention, FIG. 1(b) is a side view of a helisert, and FIG. 1(c) is a side view of a cutting head.

FIG. 2 is a side view of the cutting tool.

FIG. 3 are graphs each showing a result of a cutting test.

### REFERENCE SIGNS LIST

100 cutting tool
10 main body unit
11 internal screw unit
20 helisert
30 cutting head
32 external screw unit
O axis

### DESCRIPTION OF EMBODIMENTS

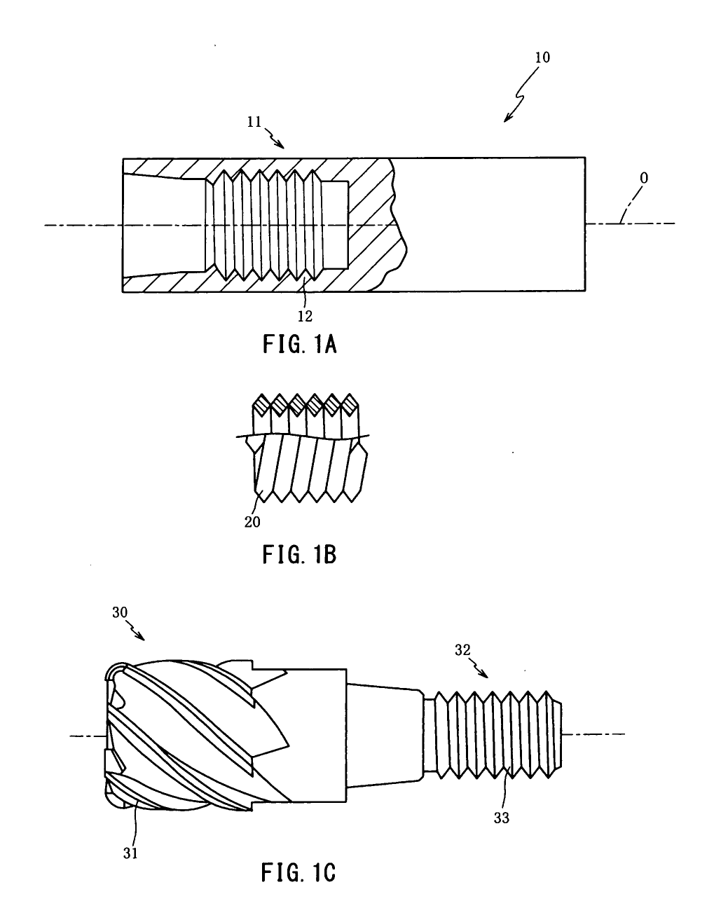

Hereinafter, a preferred embodiment of the present invention will be described with reference to the accompanying drawings. In the first place, configurations of respective units of a cutting tool 100 in the embodiment of the present invention will be described with reference to FIGS. 1. FIG. 1(a) is a side view of a main body unit 10 configuring the cutting tool 100 in the embodiment of the present invention, FIG. 1(b) shows a side portion of a helisert 20, and FIG. 1(c) is a side view of a cutting head 30. It should be noted that FIG. 1(a) illustrates a cross section of an internal screw unit 11 of the main body unit 10, and FIG. 1(b) schematically illustrates a helisert and a cross section of a part (upper side of FIG. 1(b)) of the helisert 20 in order to facilitate understanding by simplifying the drawing.

As shown in FIG. 1(a), the main body unit 10 is made of cemented carbide obtained by pressurizing and sintering tungsten carbide (WC) or the like. Further, the main body unit 10 is formed in a columnar shape having an axis O as a central axis, and the internal screw unit 11 on the inner circumference of which an internal screw is threaded is provided in a concave manner at an end (left side of FIG. 1(a)) of the main body unit 10. It should be noted that the internal screw is threaded using a hand tap exclusively for the helisert. In the embodiment, the core diameter, the maximum effective diameter, and the minimum effective diameter of a thread 12 of the internal screw are set at 6.04 mm, 5.596 mm and 5.520 mm, respectively.

As shown in FIG. 1(b), the helisert 20 is a member in a coil shape configured using a stainless wire with a cross section of a diamond shape. Further, the helisert 20 can be mounted in the internal screw unit 11. In the embodiment, the maximum free outer diameter (outer diameter before the helisert 20 is inserted into the internal screw unit 11) is set at 6.62 mm, the minimum free outer diameter is set at 6.36 mm, the maximum inner diameter is set at 4.294 mm, the minimum inner diameter is set at 4.134 mm, and the number of free coils is set at 7.125.

As shown in FIG. 1(c), the cutting head 30 is made of cemented carbide obtained by pressurizing and sintering tungsten carbide or the like. The cutting head 30 includes a blade portion 31 for cutting and processing a processed material and an external screw unit 32 which is provided in a convex manner at an end (right side of FIG. 1(c)) of the blade portion 31. An external screw is threaded on the outer circumference of the external screw unit 32. Further, the external screw can be screwed to the helisert 20, and the nominal designation and the nominal length of the external screw are set at M5×0.8 and 7.50 mm, respectively, in the embodiment.

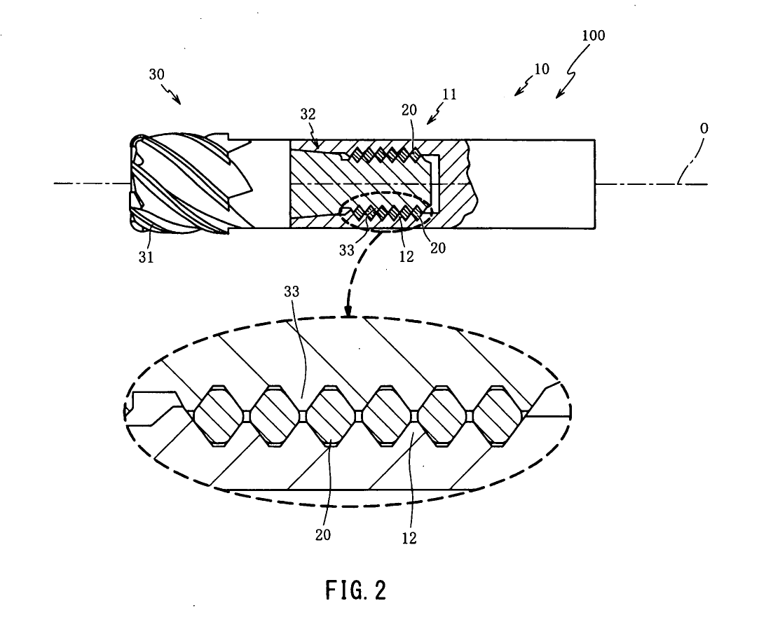

Next, a method of connecting the cutting tool 100 (see FIG. 2) will be described with reference to FIG. 1(a) to FIG. 1(c). Specifically, the helisert 20 is mounted in the internal screw unit 11 using a dedicated tool (not shown) at first. Next, the external screw unit 32 formed at the cutting head 30 is inserted into the internal screw unit 11. At this time, the external screw unit 32 is screwed to the helisert 20 mounted in the internal screw unit 11, so that the cutting head 30 is fixed to the main body unit 10.

Next, the entire configuration of the cutting tool 100 will be described with reference to FIG. 2. FIG. 2 is a side view of the cutting tool 100. It should be noted that FIG. 2 illustrates cross sections of the internal screw unit 11, the helisert 20, and the external screw unit 32.

As shown in FIG. 2, the cutting tool 100 is a connectable end mill for cutting and processing a processed material using the rotational force transmitted from a processing machine (not shown) such as a machining center. The main body unit 10 is attached to the processing machine through a holder (not shown), and the rotational force of the processing machine is transmitted to the main body unit 10 through the holder. Further, the rotational force is transmitted to the cutting head 30 connected to the main body unit 10, so that a cutting process is performed by the blade portion 31 formed at the cutting head 30.

In the cutting tool 100, the helisert 20 made of steel that is lower in rigidity than cemented carbide is provided between the external screw unit 32 and the internal screw unit 11. Accordingly, the external screw unit 32 and the internal screw unit 11 are prevented from being brought into contact with each other, so that a thread 33 of the external screw unit 32 and the thread 12 of the internal screw unit 11 can be prevented from being damaged. As a result, the frequency of replacing the main body unit 10 and the cutting head 30 due to the damage of the thread 33 of the external screw unit 32 and the thread 12 of the internal screw unit 11 is reduced, and the amount of waste of the main body unit 10 and the cutting head 30 can be suppressed.

Further, oscillation of the cutting head 30 against the main body unit 10 can be absorbed by providing the helisert 20 between the external screw unit 32 and the internal screw unit 11 because steel is lower in rigidity than cemented carbide. Further, since the helisert 20 is made of steel whose rigidity is higher than a certain level, the external screw unit 32 can be strongly fastened and fixed to the helisert 20. Thus, oscillation of the cutting head 30 at the time of a cutting process can be further suppressed. Accordingly, a cutting blade formed at the blade portion 31 can be prevented from being damaged, so that the durable period of the cutting head 30 can be prolonged and the amount of waste of the cutting head 30 can be suppressed.

It should be noted that the present invention is characterized in that the helisert 20 is mounted in the main body unit 10 made of cemented carbide that is higher in rigidity than the helisert 20 made of steel. Specifically, the above-described effects of the present invention can be obtained by providing the helisert 20 that is lower in rigidity than the external screw unit 32 and the internal screw unit 11 between the external screw unit 32 and the internal screw unit 11.

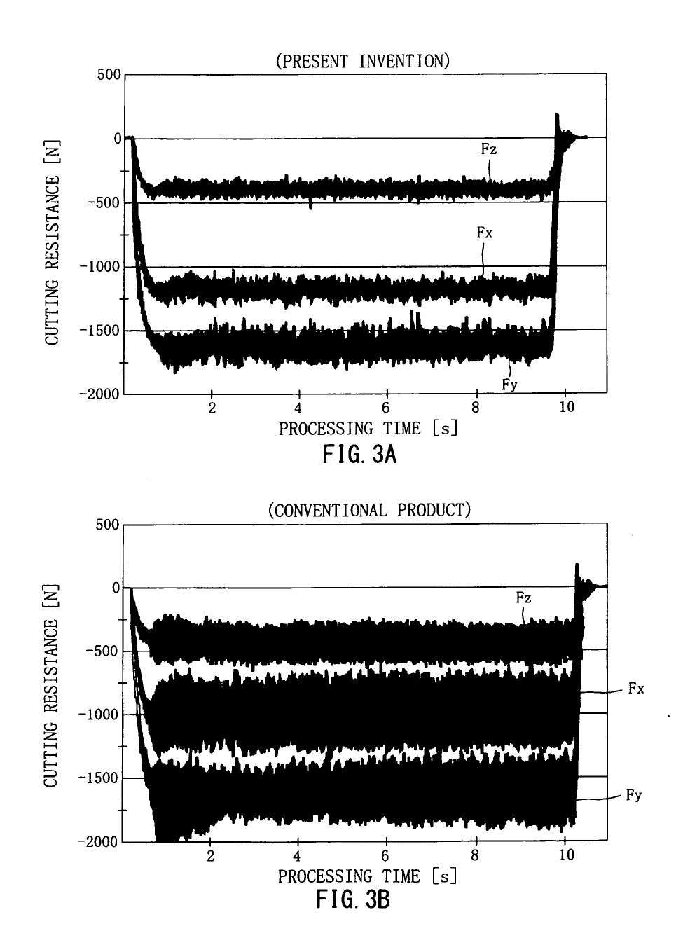

Next, a result of a cutting test will be described with reference to FIG. 3. FIG. 3(a) and FIG. 3(b) are graphs each showing the result of the cutting test. FIG. 3(a) shows the result of the cutting test using the cutting tool 100 according to the present invention, and FIG. 3(b) shows the result of the cutting test using a conventional cutting tool. This test was conducted to measure the cutting resistance applied to the cutting tools when a side of a processed material was cut and processed by the cutting tool configured as described above in accordance with the following detailed specifications. It should be noted that FIG. 3(a) and FIG. 3(b) are graphs in each of which the vertical axis represents cutting resistance and the horizontal axis represents processing time. In addition, Fy represents a horizontal force component (feeding force component) applied in the feeding direction of the cutting tool, Fx represents a vertical force component (principal force component) applied in the direction orthogonal to the feeding force component, and Fz represents a force component (thrust force component) applied in the axis direction of the cutting tool. Specifically, the principal force component, the feeding force component and the thrust force component are force components obtained by breaking down the cutting resistance into an x-axis, a y-axis, and a z-axis which are orthogonal to each other.

It should be noted that the detailed specifications of the cutting test are as follows: processed material: SUS304, processing machine: vertical machining center, coolant: aqueous coolant, cutting speed: 150 m/min, rotating speed: 4800 rpm, feeding speed: 2000 mm/min, feeding: 0.07 mm/t, cut depth: 15 mm, and cut width: 1mm.

Further, the cutting test was conducted using the cutting tool 100 (radius end mill: φ10×R1) as described in the embodiment in which the cutting head 30 was connected to the main body unit 10 through the helisert 20, and a cutting tool (hereinafter, referred to as a “conventional product”) in which a cutting head was directly connected to a main body unit. However, the conventional product is configured using the cutting head 30 having the same configuration as the present invention and the main body unit having an internal screw unit in which an internal screw to which the cutting head 30 can be screwed is formed. Further, the main body unit 10 of the present invention and the main body unit of the conventional product are different in that the internal screw unit can be screwed to the external screw unit (namely, the internal screw unit has a size of M5×0.8 same as the external screw), and the other configurations are the same.

As shown in FIG. 3(a) and FIG. 3(b), the average value of the thrust force components Fz was −400N in each of the present invention and the conventional product according to the result of the cutting test. In addition, the average value of the principal force components Fx was −1150N in the present invention, whereas it was −1000N in the conventional product. Further, the average value of the feeding force components Fy was −1650N in each of the present invention and the conventional product.

On the other hand, the average value of the amplitudes of the thrust force components Fz was 60N (namely, Fz=−400±60N) in the present invention, whereas it was 140N (namely, Fz=−400±140N) in the conventional product. In addition, the average value of the amplitudes of the principal force components Fx was 100N (namely, Fx=−1150±100N) in the present invention, whereas it was 250N (namely, Fx=−1000±250N) in the conventional product. Further, the average value of the amplitudes of the feeding force components Fy was 130N (namely, Fy=−1650±130N) in the present invention, whereas it was 210N (namely, Fy=−1650±210N) in the conventional product.

As described above, the average values of the feeding force components Fy and the thrust force components Fz were the same and have no difference between the present invention and the conventional product. In addition, the average value of the principal force components Fx in the present invention was smaller than that in the conventional product by 150N, and was smaller than that in the conventional product by 15%.

On the other hand, the average value of the amplitudes of the thrust force components Fz in the present invention was smaller than that in the conventional product by 80N, and was about 43% of the average value of the amplitudes of the thrust force components Fz in the conventional product. In addition, the average value of the amplitudes of the principal force components Fx in the present invention was smaller than that in the conventional product by 150 N, and was 40% of the average value of the amplitudes of the principal force components Fx in the conventional product. Further, the average value of the amplitudes of the feeding force components Fy in the present invention was smaller than that in the conventional product by 80N, and was about 62% of the average value of the amplitudes of the feeding force components Fy in the conventional product. Namely, it was confirmed that the amplitudes of cutting resistance were reduced in any directions, and oscillation at the time of a cutting process was reduced. It was probably because the oscillation of the cutting head 30 could be absorbed by the helisert 20 mounted in the internal screw unit 11 in the present invention.

Specifically, the helisert 20 made of steel that is lower in rigidity than the external screw unit 32 and the internal screw unit 11 is provided between the external screw unit 32 and internal screw unit 11 made of cemented carbide as the cutting tool 100 in the embodiment, and thus the oscillation generated at the time of a cutting process can be suppressed.

The present invention has been described above on the basis of the embodiment. However, it can be easily speculated that the present invention is not limited to the above-described embodiment, but may be variously modified and changed without departing from the scope of the present invention.

For example, it is obvious that each numeric value mentioned in the above-described embodiment is an example, and other numeric values can be employed.

Further, there has been described a case in which the present invention is applied to the end mill in the above-described embodiment. However, the present invention is not necessarily limited to the case, but may be applied to a cutting tool such as a drill or a tap. Further, the present invention may be applied to a throw-away turning tool which includes a holder made of cemented carbide in which an internal screw is threaded, a chip made of cemented carbide in which an internal screw is threaded, and a helisert which is mounted in the internal screw that is threaded in the holder, and in which the chip is fixed to the holder using an external screw made of cemented carbide.

Further, there has been described a case in which the helisert 20 is made of stainless steel in the above-described embodiment. However, the present invention is not necessarily limited to the case, but helisert 20 may be made of other steel or material such as phosphorus bronze that is lower in rigidity than cemented carbide.

Furthermore, there has been described a case in which the internal screw unit 11 is provided to the main body unit 10 in a concave manner and the external screw unit 32 is provided to the cutting head 30 in a convex manner in the above-described embodiment. However, the present invention is not necessarily limited to the case, but the external screw unit may be provided to the main body unit 10 in a concave manner and the internal screw unit may be provided to the cutting head 30 in a convex manner.

Furthermore, there has been described a case in which the external screw unit 32 with the external screw threaded is provided at a rear end of the cutting head 30 in a convex manner. However, the present invention is not necessarily limited to the case, but the external screw unit may be provided at an end of the cutting head 30. It should be noted in this case that the helisert is formed in a size that can be screwed to the external screw unit, and the internal screw unit of the main body unit is formed in a size where the helisert can be mounted.

Furthermore, there has been described a case in which the external screw that is threaded in the external screw unit 32 is a right-hand screw in the embodiment. However, the present invention is not necessarily limited to the case, but the external screw that is threaded in the external screw unit may be a left-hand screw. Specifically, the external screw may be threaded in accordance with the cutting direction of the cutting head (in the direction where the screw is fastened against the cutting resistance of the cutting head).

1. A cutting tool comprising:
a main body unit made of cemented carbide, and
a cutting head made of cemented carbide which is detachably attached to a tip end of the main body unit to cut and process a processed material,
wherein an external screw unit is formed at an end of one of the main body unit and the cutting head and on the outer circumference of which an external screw is threaded, an internal screw unit is formed at an end of the other of the main body unit and the cutting head and on the inner circumference of which an internal screw is threaded, and a coil-like helisert is mounted in the internal screw unit and is lower in rigidity than cemented carbide, and the external screw unit is screwed to the helisert, so that the cutting head is fixed to the main body unit.

2. The cutting tool according to claim 1, wherein the helisert is made of steel.
